(19) United States
(12) Patent Application Publication
(10) Pub. No.: US 2006/0066101 A1
(43) Pub. Date: Mar. 30, 2006

(54) High pressure line connector

(76) Inventor: Harold E. Hollnagel, Milwaukee, WI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/954,141

(22) Filed: Sep. 29, 2004

(51) Int. Cl. F16L 39/00

(52) U.S. Cl. 285/319

(57) ABSTRACT

The quick connect member (20) has a pair of arms (32) biased radially outwardly into a locked position in radial overlapping engagement with a shoulder (25) in a socket member (21) to retain a tube (26) in the socket member (21). The arms (32) extend from a disk (34) through flat and parallel axial sections (35) and then through outwardly flared sections (36), the arms (32) being arcuate in cross section between the axial sections (35) and the ends (33) thereof to terminate in arcuate ends (33). Each of the axial sections (35) includes an opening (39) extending tangentially to the tube (26) for receiving the projection (28). The socket member (21) has a pair of oppositely disposed radial holes (38) adjacent the shoulder (25) for accessing the arms (32) by inserting a tool through the holes (38) to move the arms (32) radially inwardly to a release position to clear the shoulder (25) to axially remove the quick connect member (20) from the socket member (21) to remove the tube (26) from the bore (22) of the socket member (21).

### BACKGROUND OF THE INVENTION

1. Field of the Invention

The invention relates to a tube quick connect assembly for a quick connection between high pressure lines and, more specifically, to a quick connect member for retaining a tube in a socket member.

2. Description of the Prior Art

The art of quick connector assemblies is highly developed in the pursuit of a quick connect retainer member that is resilient for snapping into engagement with a socket member and removable yet providing the requisite retaining force, all within the desired simplicity of fabrication. Such quick connect assemblies typically include a socket member having an axial bore and defining a female cupped pocket presenting a radially extending shoulder with an end of a tube disposed in the bore and presenting a radially extending projection. The quick connect member normally includes a disk surrounding the tube and engaging the projection and having a pair of arms extending from the disk and biased radially outwardly into a locked position in radial overlapping engagement with the shoulder and to retain the tube in the bore of the socket member with the arms being moveable radially inwardly to a release position to clear the shoulder to axially remove the quick connect member from the socket member to remove the tube from bore of socket member.

Examples of such prior art assemblies are disclosed in U.S. Pat. Nos. 4,681,351: 4,778,203; 5,732,984 and 6,543,814, all to John M. Bartholomew. Additional developments have been made by McNaughton et al as disclosed in U.S. Pat. Nos. 5,324,082 and 5,350,203.

The quick connect members of the prior art are frequently of a complex shape and/or are molded of plastic with complex tooling.

### SUMMARY OF THE INVENTION AND ADVANTAGES

The invention provides quick connect member having a pair of arms with each arm extending from the disk through an axial section extending axially and then into and through an outwardly flared section extending radially outwardly to an end for engaging a shoulder in a socket for retaining the quick connect member completely within the socket in a locked position.

The invention also provides a socket member having a radial hole adjacent the shoulder over each of the arms for accessing the arms by inserting a tool through the holes to move the arms radially inwardly to the release position.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an exploded perspective view of a tube quick connect assembly of the subject invention;

FIG. 2 is a side view of the tube quick connect assembly of the subject invention;

FIG. 3 is a side view of the quick connect member of the subject invention;

FIG. 4 is a view taken along line 4-4 of FIG. 3; and

FIG. 5 is a view taken along line 5-5 of FIG. 3.

### DESCRIPTION OF PREFERRED EMBODIMENT

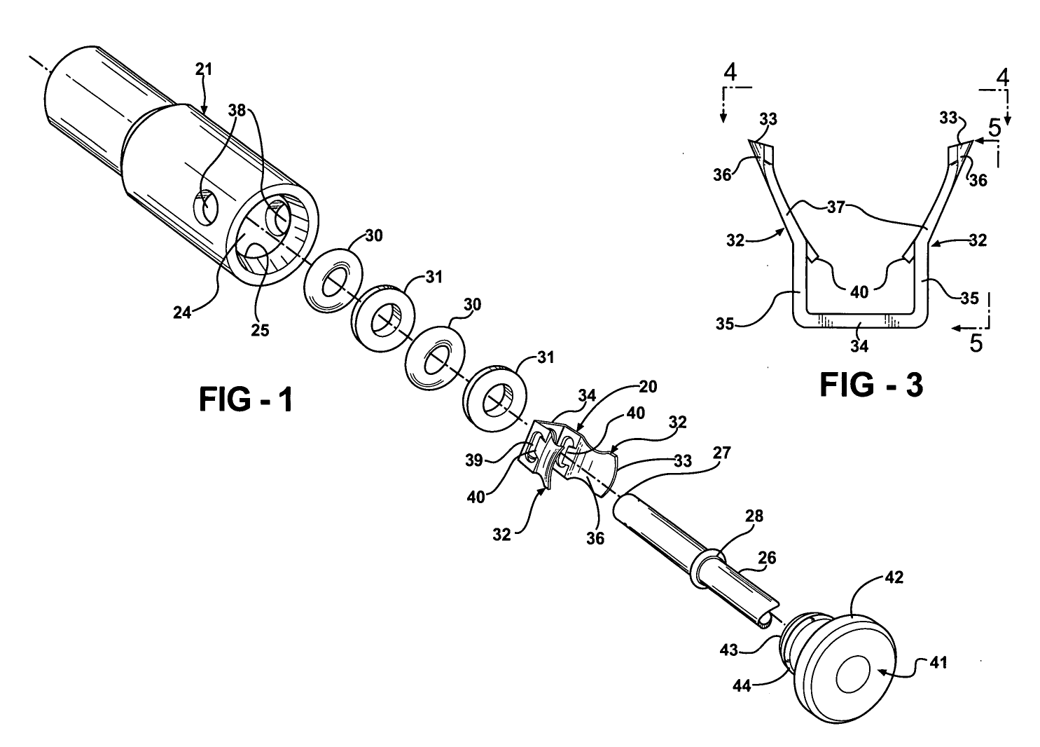

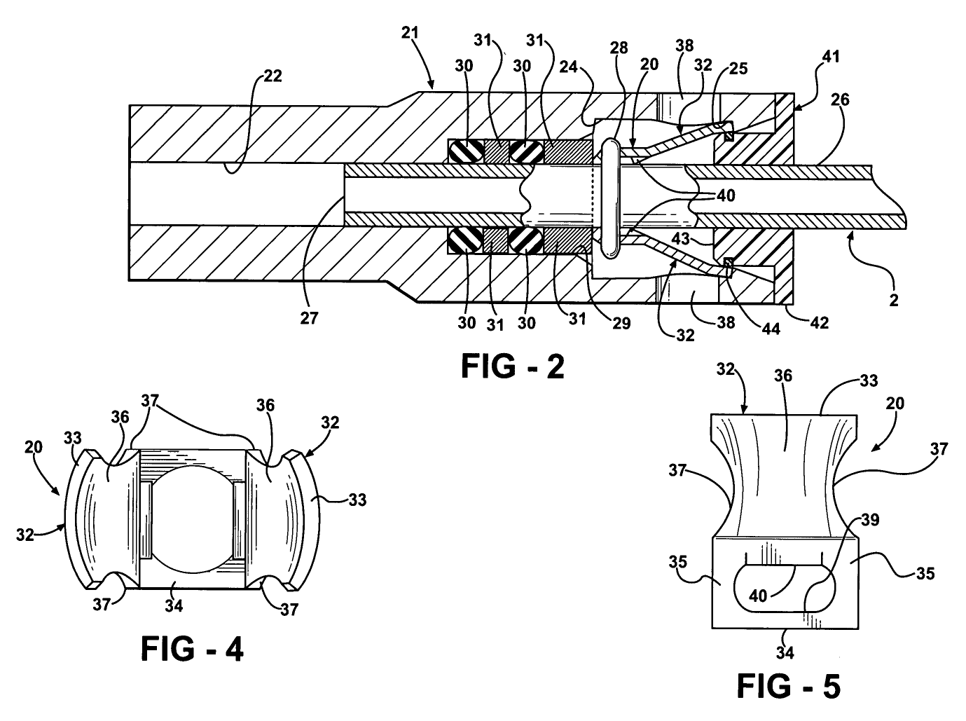

Referring to the Figures, wherein like numerals indicate corresponding parts throughout the several views, a tube quick connect assembly is shown in FIGS. 1 and 2 and a quick connect member used therein is generally shown at 20.

The quick connect assembly includes a socket member, generally indicated at 21, having an axial bore 22 and defining a female cupped pocket 24 presenting a radially extending shoulder 25 that extends annularly around the interior of the pocket 24.

A tube 26 has an end 27 disposed in the bore 22 of the socket member 21 and presents a radially extending projection 28. The socket member 21 has an enlarged or intermediate counterbore 29 between the cupped pocket 24 and the axial tube bore 22. A seal mechanism is disposed about the tube 26 between the quick connect member 20 and the tube bore 22. The seal mechanism includes a pair of O-rings 30 sandwiched by a spacers such as steel washers 31, the outside spacers not being shown in FIG. 1.

The quick connect member 20 engages the projection 28 and has a pair of arms, each generally indicated at 32, biased radially outwardly in opposite one hundred and eighty degree directions relative to one another into a locked position in radial overlapping engagement with the shoulder 25 to retain the tube 26 in the bore 22 of the socket member 21. The arms 32 are moveable radially inwardly to a release position to clear the shoulder 25 to axially remove the quick connect member 20 from the socket member 21 to remove the tube 26 from the bore 22 of the socket member 21. The quick connect member 20 is preferably made of metal with the arms 32 being flexible. Each of the arms 32 terminates at an arm end 33 engaging the shoulder 25 for retaining the quick connect member 20 completely within the cupped pocket 24 in the locked position. As alluded to above, the shoulder 25 is annular or extends in a circle and the ends 33 of the arms 32 are arcuate or circular to engage along the annular shoulder 25.

The quick connect member 20 includes a disk 34 surrounding the tube 26 and engaging one side of the projection 28 and each of the arms 32 extends from the disk 34 in and through an axial section 35 and then into and through an outwardly flared section 36 to the ends 33 of the arms 32. The axial sections 35 are flat and parallel to one another whereas the flared sections 36 of the arms 32 are arcuate in cross section between the axial sections 35 and the ends 33 thereof. More specifically, the flared sections 36 of the arms 32 increase in degree of curvature from the axial sections 35 to the ends 33 of the arms 32. In other words, the arms 32 are arcuate in cross section in an increasing radius from the ends 33 thereof toward the projection 28. In addition, each of the flared sections 36 has scalloped sides 37.

The socket member 21 has a pair of oppositely disposed radial holes 38 adjacent the shoulder 25 over or radially aligned with each of the arms 32 for accessing the arms 32 by inserting a tool (not shown) through the holes 38 to move the arms 32 radially inwardly to the release position. Each of the axial sections 35 includes an opening 39 extending tangentially to the tube 26 for receiving the projection 28.

The axial sections 35 are spring biased to be parallel to one another. Each of the axial sections 35 includes the opening 39 and a pair of spaced slits extends from each opening 39 toward the arms 32 to define a pair of tabs 40 that are bent to extend downwardly toward one another for gripping the tube 26. The tabs 40 form downwardly and inwardly directed extensions of the arms 32 to engage the tube 26 so as to retain the quick connect member 20 on the tube 26. Accordingly, the axial sections 35 parallel the tube 26 or are disposed on the opposite side of the projection 28 along the tube 26 from the disk 34.

The assembly may also include a cap, generally indicated at 41, including a flange 42 abutting the end of the socket member 21 and a nose 43 extending into the socket member 21. An annular o-ring or seal 44 is disposed in a groove in the nose 43 as the nose 43 engages the arms 32 to hold the arms 32 against the cupped pocket 24 in the open end of the socket member 21. The cap 41 may be held in place frictionally or with threads (not shown). The cap 41 acts as a redundant safety and keeps foreign matter out of the socket member 21.

in the open end of the socket member 21.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A tube quick connect assembly comprising;
a socket member (20) having an axial bore (22) and defining a female cupped pocket (24) presenting a radially extending shoulder (25),
a tube (26) having an end (27) disposed in said bore of said socket member (20) and presenting a radially extending projection (28),
a quick connect member (20) engaging said projection (28) having a pair of arms (32) biased radially outwardly in opposite directions into a locked position in radial overlapping engagement with said shoulder (25) to retain said tube (26) in said bore of said socket member (20) with said arms (32) being moveable radially inwardly to a release position to clear said shoulder (25) to axially remove said quick connect member (20) from said socket member (20) to remove said tube (26) from said bore of said socket member (20), and
characterized by said socket member (20) having a radial hole (38) adjacent said shoulder (25) over each of said arms (32) for accessing said arms (32) by inserting a tool through said holes (38) to move said arms (32) radially inwardly to said release position.

2. An assembly as set forth in claim 1 wherein each of said arms (32) terminates at an arm end (33) engaging said shoulder (25) for retaining said quick connect member (20) completely within said cupped pocket (24) in said locked position.

3. An assembly as set forth in claim 2 wherein said shoulder (25) is annular and said ends of said arms (32) are arcuate to engage along said annular shoulder (25).

4. An assembly as set forth in claim 3 wherein said arms (32) are arcuate in cross section from said ends thereof toward said projection (28).

5. An assembly as set forth in claim 3 wherein said quick connect member (20) includes a disk (34) surrounding said tube (26) and engaging said projection (28), each of said arms (32) extending from said disk (34) in an axial section (35) and then into an outwardly flared section (36) to said ends of said arms (32).

6. An assembly as set forth in claim 5 wherein each of said axial sections (35) includes an opening (39) receiving said projection (28).

7. An assembly as set forth in claim 6 wherein said axial sections (35) are flat and parallel to one another.

8. An assembly as set forth in claim 7 wherein said flared sections (36) of said arms (32) are arcuate in cross section between said axial sections (35) and said ends thereof.

9. An assembly as set forth in claim 8 wherein each of said flared sections (36) has scalloped sides (37).

10. An assembly as set forth in claim 9 wherein said axial sections (35) are spring-biased toward one another and said tube (26).

11. An assembly as set forth in claim 10 wherein each of said axial sections (35) includes an opening (39) and a pair of spaced slits extending from said opening (39) toward said arms (32) to define a pair of tabs (40) extending downwardly toward one another for gripping said tube (26).

12. An assembly as set forth in claim 11 wherein said tabs (40) engage said tube (26) on the opposite side of said projection (28) along said tube (26) from said disk.

13. An assembly as set forth in claim 10 including a seal mechanism disposed about said tube (26) between said disk (34) and said bore.

14. An assembly as set forth in claim 1 including a cap (41) extending into said socket member (21) and engaging said arms (32) to hold said arms (32) against said cupped pocket (24) in the open end of the socket member 21.

15. A tube quick connect assembly comprising;
a socket member (20) having an axial bore (22) and defining a female cupped pocket (24) presenting a radially extending shoulder (25),
a tube (26) having an end (27) disposed in said bore of said socket member (20) and presenting a radially extending projection (28),
a quick connect member (20) including a disk (34) surrounding said tube (26) and engaging said projection (28) and having a pair of arms (32) extending from said disk (34) and biased radially outwardly into a locked position in radial overlapping engagement with said shoulder (25) and to retain said tube (26) in said bore of said socket member (20) with said arms (32) being moveable radially inwardly to a release position to clear said shoulder (25) to axially remove said quick connect member (20) from said socket member (20) to remove said tube (26) from said bore of said socket member (20), and
characterized by each of said pair of arms (32) extending from said disk (34) in an axial section (35) and then into an outwardly flared section (36) to an arm end (33) engaging said shoulder (25) for retaining said quick connect member (20) completely within said cupped pocket (24) in said locked position.

16. A tube quick connect assembly comprising;
a socket member (20) having an axial bore (22) and defining a female cupped pocket (24) presenting a radially extending shoulder (25),
a tube (26) having an end (27) disposed in said bore of said socket member (20) and presenting a radially extending projection (28),
a quick connect member (20) including a disk (34) surrounding said tube (26) and engaging said projection (28) and having a pair of arms (32) extending from said disk (34) and biased radially outwardly into a locked position in radial overlapping engagement with said shoulder (25) and to retain said tube (26) in said bore of said socket member (20) with said arms (32) being moveable radially inwardly to a release position to clear said shoulder (25) to axially remove said quick connect member (20) from said socket member (20) to remove said tube (26) from said bore of said socket member (20), and
characterized by each of said pair of arms (32) extending from said disk (34) in an axial section (35) and then into an outwardly flared section (36) to an arm end (33) engaging said shoulder (25) for retaining said quick connect member (20) completely within said cupped pocket (24) in said locked position.

17. An assembly as set forth in claim 16 wherein said shoulder (25) is annular and said ends of said arms (32) are arcuate to engage along said annular shoulder (25).

18. An assembly as set forth in claim 17 wherein each of said axial sections (35) includes an opening (39) receiving said projection (28).

19. An assembly as set forth in claim 17 wherein said axial sections (35) are flat and parallel to one another.

20. An assembly as set forth in claim 17 wherein each of said axial sections (35) includes an opening (39) and a pair of spaced slits extending from said opening (39) toward said arms (32) to define a pair of tabs (40) extending downwardly toward one another for gripping said tube (26).

21. An assembly as set forth in claim 19 wherein said flared sections (36) of said arms (32) are arcuate in cross section between said axial sections (35) and said ends.

22. A quick connect member (20) comprising;
a disk (34) for surrounding a tube (26) and engaging a radial projection (28) from the tube (26), and
characterized by a pair of arms (32) with each arm extending from said disk (34) through an axial section (35) extending axially and then into and through an outwardly flared section (36) extending radially outwardly to an arm end (33) for engaging a shoulder (25) in a cupped pocket (24) for retaining said quick connect member (20) completely within the cupped pocket (24) in a locked position.

23. A quick connect member (20) as set forth in claim 22 wherein said ends of said arms (32) are arcuate to engage along an annular shoulder (25) in the cupped pocket (24).

24. A quick connect member (20) as set forth in claim 23 wherein said axial sections (35) are flat and parallel to one another.

25. A quick connect member (20) as set forth in claim 24 wherein each of said axial sections (35) includes an opening (39) for receiving the projection (28) from the tube (26).

26. A quick connect member (20) as set forth in claim 25 wherein each of said axial sections (35) includes an opening (39) and a pair of spaced slits extending from said opening (39) toward said arms (32) to define a pair of tabs (40) extending downwardly toward one another for gripping the tube (26).

27. A quick connect member (20) as set forth in claim 25 wherein said flared sections (36) of said arms (32) are arcuate in cross section between said flat axial sections (35) and said ends.
